(19) United States
(12) Patent Application Publication
(10) Pub. No.: US 2023/0336099 A1
(43) Pub. Date: Oct. 19, 2023

(54) ROTATABLE DRAWING BOARD AND CONTROL METHOD

(71) Applicant: Shenzhen zhongdaxin Epoxy plate Co. Ltd., Shenzhen (CN)

(72) Inventor: Shengwen Huang, Anxiang (CN)

(21) Appl. No.: 18/335,925

(22) Filed: Jun. 15, 2023

(30) Foreign Application Priority Data
Jun. 7, 2023 (CN) 202310672777.1

(51) Int. Cl. H02P 7/22; G06F 3/0354

(52) U.S. Cl. CPC H02P 7/22; G06F 3/03545

(57) ABSTRACT

The present disclosure provides a rotatable drawing board and a control method. The rotatable drawing board includes a main case and an axially rotatable drawing board body arranged on a front surface of the main case; a control circuit board and a drive motor for driving the drawing board body to axially rotate are arranged inside the main case; an output shaft of the drive motor is connected to a central portion of the drawing board body, or a supporting rod extending into the main case is arranged at a central portion of a back surface of the drawing board body; the output shaft of the drive motor is rotatably movably connected to the supporting rod to drive the supporting rod and the drawing board body to axially rotate; and the drive motor is electrically connected to the control circuit board.

### TECHNICAL FIELD

The present disclosure relates to the technical field of rotatable drawing board products, and in particular, to a rotatable drawing board with an outstanding application effect, and a control method.

### BACKGROUND

A drawing board is a type of painter for work or entertainment. With the continuous improvement of the quality of life, there have been significant improvements on many aspects of drawing boards, such as structural composition, functional characteristics, and humanization. For example, some drawing boards support manual axial angle adjustment to meet higher use convenience, while some drawing boards support automatic or manual light adjustment to meet use needs of different environmental.

The invention patent No. CN202211228904.0, entitled “Foldable Toy Drawing Board”, specifically discloses a foldable toy drawing board, including a drawing board, an outer frame, and a supporting frame. A first hinge handle is arranged on a side wall of the drawing board; the drawing board is hinged inside the outer frame through the first hinge handle; a rear side of the outer frame is hinged with a first folding component. the folding component includes a first folding arm, a second folding arm, a threaded sleeve, and a rotating disk; one end of the first folding arm is hinged to the rear side of the outer frame, and the other end is hinged with one end of the second folding arm; the other end of the second folding arm is hinged to the rotating disk; threads are formed on exteriors of the hinged ends of both the first folding arm and the second folding arm, and the threaded sleeve is rotatably arranged on the first folding arm; and the rotating disk is rotatably arranged at an upper end of the supporting frame. In this invention, the entire drawing board can be adjusted in angle, and the outer frame can rotate under the action of the first folding component. At the same time, the entire outer frame can rotate relative to the supporting frame to meet different needs of users for angles of the drawing board.

Although the above design in the prior art solves the problem of overall rotation of the outer frame to adjust the angle of the drawing board, the user experience is poor because the angle is manually adjusted. Furthermore, there are many structural components, which is not conducive to maintenance.

Based on this, it is necessary to design a more intelligent and convenient drawing board product on the basis of the idea of the prior art.

### SUMMARY

The present application solves the following problems in the prior art:

Although the design in the prior art solves the problem of overall rotation of the outer frame to adjust the angle of the drawing board, the user experience is poor because the angle is manually adjusted. Furthermore, there are many structural components, which is not conducive to maintenance.

Solutions used by the present disclosure to solve the technical problems are as follows:

A rotatable drawing board and a control method are provided. The rotatable drawing board includes a main case and an axially rotatable drawing board body arranged on a front surface of the main case, wherein a control circuit board and a drive motor for driving the drawing board body to axially rotate are arranged inside the main case;
an output shaft of the drive motor is connected to a central portion of the drawing board body, or a supporting rod extending into the main case is arranged at a central portion of a back surface of the drawing board body; the output shaft of the drive motor is rotatably movably connected to the supporting rod to drive the supporting rod and the drawing board body to axially rotate; and
the drive motor is electrically connected to the control circuit board.

Preferably, a plurality of sensing switches used for sensing a usage state or a stress state of the drawing board body are further arranged at a portion between the main case and the drawing board body or on an inner side of the main case.

Preferably, each sensing switch is a pressure sensing switch or a distance sensing switch;
a press spring used for playing an elastic restoration role is further arranged on the inner side of the main case; and the press spring is located at a bottom of the drive motor or is located at the other end portion of the drawing board body opposite to the supporting rod.

Preferably, a motor cover used for accommodating and mounting the drive motor is further arranged inside the main case;
an outer side of the motor cover is connected to the main case; and a shaft hole for arranging the output shaft in a penetrating manner is formed in an upper part of the motor cover.

Preferably, a spring limiting post used for accommodating and arranging the press spring is further integrally arranged on the inner side of the main case;
the drive motor is located at an upper part of the spring limiting post; a lower part of the drive motor is in contact with a top of the press spring;
a limiting slot is formed in the spring limiting post; a limiting post corresponding to the limiting slot is arranged at the lower part of the drive motor; the limiting post is embedded into the limiting slot to limit up-and-down movement of the drive motor;
or, a motor limiting post matched with the spring limiting post is arranged at the lower part of the drive motor; and the entire motor limiting post is movably clamped into the spring limiting post or sleeves an outer side of the spring limiting post to limit up-and-down movement of the drive motor.

Preferably, the main case includes a lower case and an upper case matched and abutted with an upper part of the lower case; the drawing board body is located on an inner side of the upper case;
the upper case is of a circular ring shape or a circular drawing board accommodating hole used for matching and accommodating the drawing board body is formed in a portion of the drawing board body;
the plurality of sensing switches are arranged on an inner side of the lower case in a surrounding manner; and switch mounting slots used for mounting the sensing switches are further formed in the upper part of the lower case.

Preferably, a control button used for controlling the drive motor to run is further arranged on an outer side of the main case; or a wireless communication module is arranged inside the main case to receive an external control signal to control the drive motor to run; or the outer side of the main case is connected with a USB connector to supply power or transmit a signal.

Preferably, a cross section of the upper case is of an inverted L-shaped structure; and
a diameter of the drawing board body is slightly greater than a hole diameter of the drawing board accommodating hole of the upper case, to avoid the drawing board body from falling out from the drawing board accommodating hole.

A control method for a rotatable drawing board includes the following steps:
S1: preparing any one of the above rotatable drawing boards;
S2: spinning a start switch, adjusting a rotating speed, and controlling the drive motor to run, wherein the drive motor drives the drawing board body to axially rotate;
S3: enabling a stylus of a user to be in contact with or press the drawing board body to trigger the sensing switches;
S4: transmitting, by the sensing switches, a signal to the control circuit board, and immediately controlling, by the control circuit board, the drive motor to stop running;
S5: enabling the stylus of the user to leave the drawing board body, transmitting, by the sensing switches, a signal to the control circuit board, and controlling, by the control circuit board, the drive motor to restart to run or manually pressing, by the user, a running button to control the drive motor to rerun; and
S6: repeating step S3 to step S5.

Preferably, the entire rotatable drawing board is of a round cake shape; the drive motor is located at an internal central portion of the main case; the sensing switches are pressure sensing switches; and the drawing board body deviates downwards after being pressed, and is in contact with the pressure sensing switches to trigger the pressure sensing switches.

Technical effects achieved by the present disclosure by solving the technical problems are as follows:

Compared with the prior art, the present disclosure provides a rotatable drawing board and a control method. A main case 11 and an axially rotatable drawing board body 12 arranged on a front surface of the main case 11 are simultaneously arranged; a control circuit board and a drive motor 13 for driving the drawing board body 12 to axially rotate are arranged inside the main case 11; an output shaft of the drive motor 13 is connected to a central portion of the drawing board body 12, or a supporting rod extending into the main case 11 is arranged at a central portion of a back surface of the drawing board body 12; the output shaft of the drive motor 13 is rotatably movably connected to the supporting rod to drive the supporting rod and the drawing board body 12 to axially rotate; and the drive motor 13 is electrically connected to the control circuit board. In an actual application process, the drive motor 13 can be better used to drive the drawing board body 12 to self-rotate, which improves the use experience and improves the problem of inconvenient manual operations in the traditional technology. In addition, a rotating speed can be controlled to achieve different pattern displaying effects at different rotating speeds.

### BRIEF DESCRIPTION OF THE DRAWINGS

FIG. 1 is a schematic structural diagram of a rotatable drawing board in a three-dimensional state according to the present disclosure.

FIG. 2 is a schematic structural diagram of a rotatable drawing board in an exploded state according to the present disclosure.

FIG. 3 is a schematic enlarged diagram of the part A in FIG. 2.

FIG. 4 is a schematic structural diagram of a rotatable drawing board in a sectional state according to the present disclosure.

In the drawings: main case 11; control button 111; upper case 112; lower case 113; switch mounting slot 114; spring limiting post 115; limiting slot 117; drawing board body 12; drive motor 13; press spring 132; motor cover 14; and sensing switch 15.

### DETAILED DESCRIPTION OF THE EMBODIMENTS

In order to make the objectives, technical solutions and advantages of the present disclosure clearer, the present disclosure is further described below in detail with reference to accompanying drawings and embodiments. It should be understood that the specific embodiments described here are merely to explain the present disclosure, and not intended to limit the present disclosure.

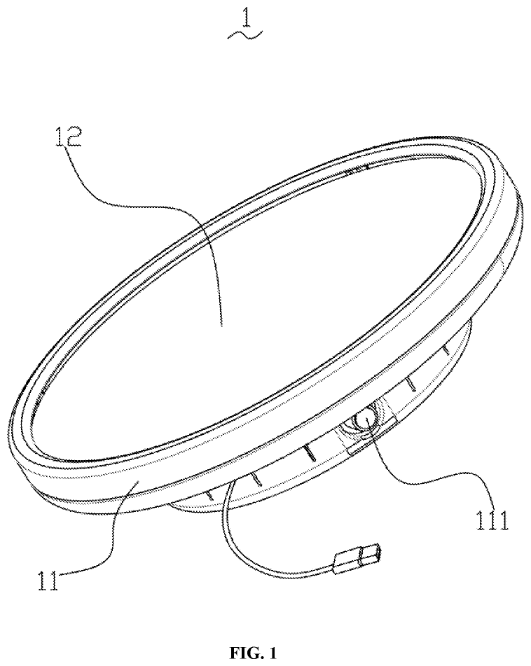

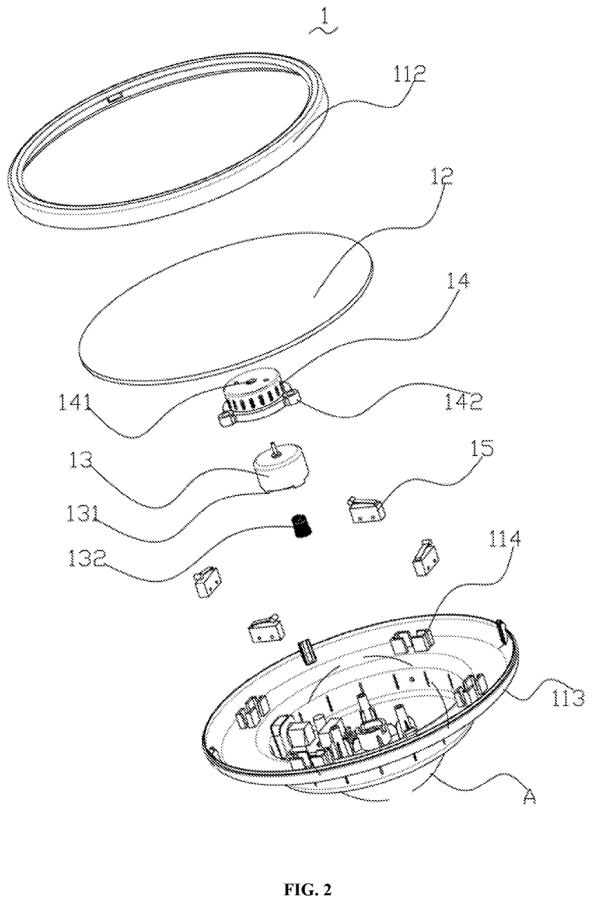

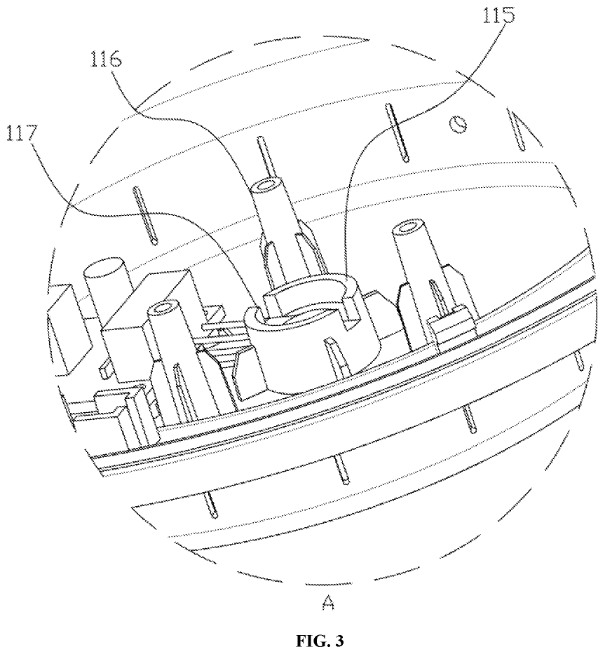

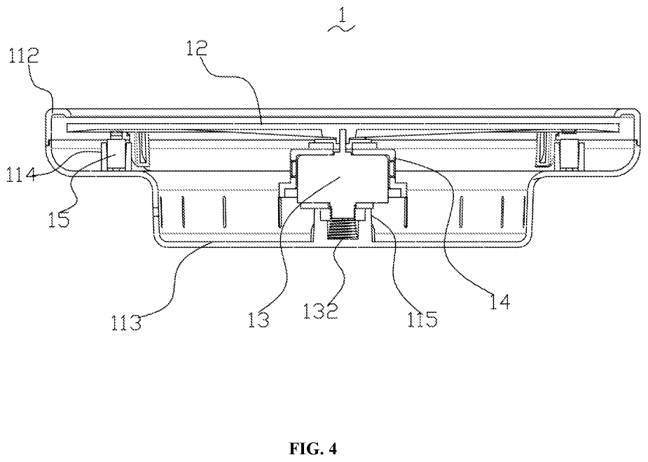

Referring to FIG. 1 to FIG. 4, a rotatable drawing board 1 of the present disclosure includes a main case 11 and an axially rotatable drawing board body 12 arranged on a front surface of the main case 11. A control circuit board and a drive motor 13 for driving the drawing board body 12 to axially rotate are arranged inside the main case 11. The main case 11 may be round or in other shapes, which will not be specifically restrained in the present disclosure.

An output shaft of the drive motor 13 is connected to a central portion of the drawing board body 12, or a supporting rod extending into the main case 11 is arranged at a central portion of a back surface of the drawing board body 12. The output shaft of the drive motor 13 is rotatably movably connected to the supporting rod to drive the supporting rod and the drawing board body 12 to axially rotate. The above rotatable movable connection may be gearing or the like, and transmission structures related thereto all fall within equivalent technical solutions. The drive motor 13 is electrically connected to the control circuit board.

According to the present disclosure, the main case 11 and the axially rotatable drawing board body 12 arranged on the front surface of the main case 11 are simultaneously arranged; the control circuit board and the drive motor 13 for driving the drawing board body 12 to axially rotate are arranged inside the main case 11; the output shaft of the drive motor 13 is connected to the central portion of the drawing board body 12, or the supporting rod extending into the main case 11 is arranged at the central portion of the back surface of the drawing board body 12; the output shaft of the drive motor 13 is rotatably movably connected to the supporting rod to drive the supporting rod and the drawing board body 12 to axially rotate; and the drive motor 13 is electrically connected to the control circuit board. In an actual application process, the drive motor 13 can be better used to drive the drawing board body 12 to self-rotate, which improves the use experience and improves the problem of inconvenient manual operations in the traditional technology. In addition, a rotating speed can be controlled to achieve different pattern displaying effects at different rotating speeds.

A drawing surface of the drawing board body 12 of the present disclosure is smooth. An erasable stylus can be used to make a drawing which can be erased, so that the drawing board can be basically repeatedly used.

Another objective of the present disclosure is to provide a drawing board with a rotating function. The drawing board is rotated at a controllable rotating speed. Due to an automatic start and stop function, a visual delay is achieved, and dynamic patterns are generated. Different patterns are generated at different rotating speeds.

Sensing switches 15 can be uniformly distributed at respective quartiles of the device and located under the round drawing board, and control the preferred rotatable drawing board. When a stylus is in contact with the rotatable drawing board, the sensing switches 15 are stressed to cut off the power to stop the drawing board. When the stylus leaves the drawing board, the motor is electrified and drives the drawing board to rotate.

The drawing board body 12 of the present disclosure basically has a smooth surface and is basically round. The present disclosure will be better understood. Further, objects, features, and advantages will be clearer in the descriptions (in combination with the drawings) of the following preferred embodiments.

In some other embodiments, sensing switches 15 used for sensing a usage state or a stress state of the drawing board body 12 are further arranged at a portion between the main case 11 and the drawing board body 12 or on an inner side of the main case 11.

Each sensing switch 15 is a pressure sensing switch or a distance sensing switch, for example, an infrared sensing switch and a sensor.

A press spring 132 used for playing an elastic restoration role is further arranged on the inner side of the main case 11. The press spring 132 is located at a bottom of the drive motor 13 or is located at the other end portion of the drawing board body 12 opposite to the supporting rod.

A motor cover 14 used for accommodating and mounting the drive motor 13 is further arranged inside the main case 11.

An outer side of the motor cover 14 is connected to the main case 11. A shaft hole for arranging the output shaft in a penetrating manner is formed in an upper part of the motor cover 14.

In an actual design, the motor cover 14 can be connected to the inner side of the main case 11 through a stud.

A spring limiting post 115 used for accommodating and arranging the press spring 132 is further integrally arranged on the inner side of the main case 11.

The drive motor 13 is located at an upper part of the spring limiting post 115, and a lower part of the drive motor 13 is in contact with a top of the press spring 132.

A limiting slot 117 is formed in the spring limiting post 115. A limiting post 131 corresponding to the limiting slot 117 is arranged at the lower part of the drive motor 13. The limiting post 131 is embedded into the limiting slot 117 to limit up-and-down movement of the drive motor 13.

Or, a motor limiting post matched with the spring limiting post 115 is arranged at the lower part of the drive motor 13. The entire motor limiting post is movably clamped into the spring limiting post 115 or sleeves an outer side of the spring limiting post 115 to limit up-and-down movement of the drive motor 13.

The design and setting of the above limiting structures are mainly to enable the drive motor 13 to move up and down stably, thereby avoiding deviation in angle from affecting a switch triggering effect.

The main case 11 includes a lower case 113 and an upper case 112 matched and abutted with an upper part of the lower case 113. The drawing board body 12 is located on an inner side of the upper case 112.

The upper case 112 is of a circular ring shape or a circular drawing board accommodating hole used for matching and accommodating the drawing board body 12 is formed in a portion corresponding to the drawing board body 12.

The plurality of sensing switches 15 are arranged on an inner side of the lower case 113 in a surrounding manner, and switch mounting slots 114 used for mounting the sensing switches 15 are further formed in the upper part of the lower case 113.

A control button 111 used for controlling the drive motor 13 to run is further arranged on an outer side of the main case 11; or a wireless communication module is arranged inside the main case 11 to receive an external control signal to control the drive motor 13 to run; or the outer side of the main case is connected with a USB connector to supply power or transmit a signal.

A cross section of the upper case 112 is of an inverted L-shaped structure.

A diameter of the drawing board body 12 is slightly greater than a hole diameter of the drawing board accommodating hole of the upper case 112, to avoid the drawing board body 12 from falling out from the drawing board accommodating hole.

The structure of the upper case 112 is used to limit the drawing board body 12.

A control method for a rotatable drawing board includes the following steps:
S1: preparing any one of the above rotatable drawing boards 1;
S2: spinning a start switch, adjusting a rotating speed, and controlling the drive motor 13 to run, wherein the drive motor 13 drives the drawing board body 12 to axially rotate;
S3: enabling a stylus of a user to be in contact with or press the drawing board body 12 to trigger the sensing switches 15;
S4: transmitting, by the sensing switches 15, a signal to the control circuit board, and immediately controlling, by the control circuit board, the drive motor 13 to stop running;
S5: enabling the stylus of the user to leave the drawing board body 12, transmitting, by the sensing switches 15, a signal to the control circuit board, and controlling, by the control circuit board, the drive motor 13 to restart to run or manually pressing, by the user, a running button to control the drive motor 13 to rerun; and
S6: repeating step S3 to step S5.

The entire rotatable drawing board 1 is of a round cake shape. The drive motor 13 is located at an internal central portion of the main case 11. The sensing switches 15 are pressure sensing switches. The drawing board body 12 deviates downwards after being pressed, and is in contact with the pressure sensing switches to trigger the pressure sensing switches.

Technical effects achieved by the present disclosure by solving the technical problems are as follows:

Compared with the prior art, the present disclosure provides a rotatable drawing board 1. A main case 11 and an axially rotatable drawing board body 12 arranged on a front surface of the main case 11 are simultaneously arranged; a control circuit board and a drive motor 13 for driving the drawing board body 12 to axially rotate are arranged inside the main case 11; an output shaft of the drive motor 13 is connected to a central portion of the drawing board body 12, or a supporting rod extending into the main case 11 is arranged at a central portion of a back surface of the drawing board body 12; the output shaft of the drive motor 13 is rotatably movably connected to the supporting rod to drive the supporting rod and the drawing board body 12 to axially rotate; and the drive motor 13 is electrically connected to the control circuit board. In an actual application process, the drive motor 13 can be better used to drive the drawing board body 12 to self-rotate, which improves the use experience and improves the problem of inconvenient manual operations in the traditional technology. In addition, a rotating speed can be controlled to achieve different pattern displaying effects at different rotating speeds.

The above-mentioned implementations of the present disclosure do not constitute a limitation on the protection scope of the present disclosure. Any modification, equivalent replacement, and improvement made within the spirit and principle of the present disclosure shall fall within the protection scope of the claims of the present disclosure.

What is claimed is:

1. A rotatable drawing board, comprising a main case and an axially rotatable drawing board body arranged on a front surface of the main case, wherein a control circuit board and a drive motor for driving the drawing board body to axially rotate are arranged inside the main case;
an output shaft of the drive motor is connected to a central portion of the drawing board body, or a supporting rod extending into the main case is arranged at a central portion of a back surface of the drawing board body; the output shaft of the drive motor is rotatably movably connected to the supporting rod to drive the supporting rod and the drawing board body to axially rotate; and
the drive motor is electrically connected to the control circuit board.

2. The rotatable drawing board according to claim 1, wherein a plurality of sensing switches used for sensing a usage state or a stress state of the drawing board body are further arranged at a portion between the main case and the drawing board body or on an inner side of the main case.

3. The rotatable drawing board according to claim 2, wherein each sensing switch is a pressure sensing switch or a distance sensing switch;
a press spring used for playing an elastic restoration role is further arranged on the inner side of the main case; and the press spring is located at a bottom of the drive motor or is located at the other end portion of the drawing board body opposite to the supporting rod.

4. The rotatable drawing board according to claim 1, wherein a motor cover used for accommodating and mounting the drive motor is further arranged inside the main case;
an outer side of the motor cover is connected to the main case; and a shaft hole for arranging the output shaft in a penetrating manner is formed in an upper part of the motor cover.

5. The rotatable drawing board according to claim 3, wherein a spring limiting post used for accommodating and arranging the press spring is further integrally arranged on the inner side of the main case;
the drive motor is located at an upper part of the spring limiting post; a lower part of the drive motor is in contact with a top of the press spring;
a limiting slot is formed in the spring limiting post; a limiting post corresponding to the limiting slot is arranged at the lower part of the drive motor; the limiting post is embedded into the limiting slot to limit up-and-down movement of the drive motor;
or, a motor limiting post matched with the spring limiting post is arranged at the lower part of the drive motor; and the entire motor limiting post is movably clamped into the spring limiting post or sleeves an outer side of the spring limiting post to limit up-and-down movement of the drive motor.

6. The rotatable drawing board according to claim 2, wherein the main case comprises a lower case and an upper case matched and abutted with an upper part of the lower case; the drawing board body is located on an inner side of the upper case;
the upper case is of a circular ring shape or a circular drawing board accommodating hole used for matching and accommodating the drawing board body is formed in a portion corresponding to the drawing board body;
the plurality of sensing switches are arranged on an inner side of the lower case in a surrounding manner; and switch mounting slots used for mounting the sensing switches are further formed in the upper part of the lower case.

7. The rotatable drawing board according to claim 1, wherein
a control button used for controlling the drive motor to run is further arranged on an outer side of the main case, and/or the outer side of the main case is connected with a USB connector to supply power or receive an external control signal, so as to control the drive motor to run.

8. The rotatable drawing board according to claim 6, wherein a cross section of the upper case is of an inverted L-shaped structure; and
a diameter of the drawing board body is slightly greater than a hole diameter of the drawing board accommodating hole of the upper case, to avoid the drawing board body from falling out from the drawing board accommodating hole.

9. A control method for a rotatable drawing board, comprising the following steps:
S1: preparing the rotatable drawing board according to claim 2;
S2: spinning a start switch, adjusting a rotating speed, and controlling the drive motor to run, wherein the drive motor drives the drawing board body to axially rotate;
S3: enabling a stylus of a user to be in contact with or press the drawing board body to trigger the sensing switches;
S4: transmitting, by the sensing switches, a signal to the control circuit board, and immediately controlling, by the control circuit board, the drive motor to stop running;
S5: enabling the stylus of the user to leave the drawing board body, transmitting, by the sensing switches, a signal to the control circuit board, and controlling, by the control circuit board, the drive motor to restart to run or manually pressing, by the user, a running button to control the drive motor to rerun; and
S6: repeating step S3 to step S5.

10. The control method for the rotatable drawing board according to claim 9, wherein the entire rotatable drawing board is of a round cake shape; the drive motor is located at an internal central portion of the main case; the sensing switches are pressure sensing switches; and the drawing board body deviates downwards after being pressed, and is in contact with the pressure sensing switches to trigger the pressure sensing switches.
